(19) United States
(12) Patent Application Publication
(10) Pub. No.: US 2009/0032366 A1
(43) Pub. Date: Feb. 5, 2009

(54) PISTON FOR AUTOMATIC TRANSMISSION

(75) Inventor: Kiichiro GOTO, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/184,654

(22) Filed: Aug. 1, 2008

(30) Foreign Application Priority Data
Aug. 3, 2007 (JP) 2007-203071

(51) Int. Cl. F16D 25/0635

(52) U.S. Cl. 192/85 AA

(57) ABSTRACT

To satisfy sealing ability and separation load between a seal ring and a piston main body 1, a piston 100 for an automatic transmission comprises a piston main body 1 and a seal ring 2 fitted thereto, the seal ring 2 integrally has a seal main body 22 of a rubber-like elastic material and a metal ring 21 comprising a fitting cylinder portion 211 fitted to a cylindrical portion 12 of the piston main body 1, an enlarged diameter portion 212 formed adjacently thereto, and a flange portion 213 opposed to a pressure receiving portion 11 of the piston main body 1, and the seal main body 22 comprises a seal lip 221 slidably contacted with a inner surface of a clutch cylinder 3, and a compression seal portion 224 provided on an inner periphery of the enlarged diameter portion 212 to be compressed with the cylindrical portion 12.

### BACKGROUND OF THE INVENTION

1. Field of the Invention

The present invention relates to a piston used for a hydraulic pressure clutch of an automatic transmission of a vehicle.

2. Description of the Conventional Art

As for a hydraulic pressure clutch in an automatic transmission of a vehicle, when a piston (a clutch piston) moved in an axial direction in a clutch cylinder by hydraulic pressure presses and contacts drive plates at a driving shaft side to driven plates at a driven shaft side in a multiple disc clutch, power is transmitted from the driving shaft to the driven shaft. When the pressing and contacting state is released, the power transmission is intercepted. Further, generally, this kind of the clutch piston is a seal integrated piston (also called as a bonded piston seal) having a seal portion integrated with a piston main body, where the seal portion is made of a rubber-like elastic material and contacted with an inner surface of the clutch cylinder.

Such the automatic transmission is in the tendency to have multiple stages in recent years. Since an FF (a front wheel drive) system gives a restricted space in the axial direction, a clutch piston tends to enlarge in diameter especially in a case of an automatic transmission having a large capacity. However, in a case that the clutch piston is the seal integrated piston described above, when the seal integrated piston having a large diameter will be produced, a mold apparatus for integrally molding the seal portion with the piston main body is increased in size. Therefore, a production cost is inevitably increased.

Therefore, as disclosed in Unexamined Japanese Patent Publication No. 2003-139249, Unexamined Japanese Patent Publication No. 2006-2915, and Unexamined Japanese Patent Publication No. 2006-29576, a technique in which a seal ring is produced as a separate member from a piston main body and then tightly fitted to the piston body, has been conventionally developed.

However, when a cylindrical portion of a metal ring in the seal ring is in metal contact with a cylindrical portion of the piston main body at respective fitting portions thereof, sealing ability between the seal ring and the piston main body is insufficient, and thus hydraulic pressure to press a piston toward a multiple disc clutch side cannot be kept. Therefore, Unexamined Japanese Patent Publication No. 2003-139249 and Unexamined Japanese Patent Publication No. 2006-2915 disclose a structure in which the seal ring has a seal lip or a bead at the inner peripheral side of a metal ring, and the seal lip or the bead is made of a rubber-like elastic material and is tightly contacted with a pressure receiving surface of the piston main body, in order to improve the sealing ability between a seal ring and a piston main body. However, even in such the structure, when a fitting position of a metal ring with respect to a piston main body has an error in an axial direction, tightness of contact between the seal lip or the bead and the pressure receiving surface of the piston main body is decreased, and thus hydraulic pressure may not be kept.

On the other hand, Unexamined Japanese Patent Publication No. 2006-29576 discloses a structure in which a seal portion made of a rubber-like elastic material is formed on an inner peripheral surface of a cylindrical portion of a metal ring, and the seal portion is tightly contacted with an outer peripheral surface of a cylindrical portion of a piston main body in a compressed state in a radial direction. Thus, the sealing ability between the seal ring and the piston main body is improved. Therefore, hydraulic pressure to press a piston toward the multiple disc clutch side can be properly kept. However, in this case, a fitting force (separation load) of the seal ring with respect to the piston main body is lower than that in the case of metals being fitted to each other. Thus, the seal ring may be dropped from the piston main body.

### SUMMARY OF THE INVENTION

### Problem to be Solved by the Invention

The present invention is to solve these problems, and an objective of the present invention is to provide a piston for an automatic transmission having a structure in which a seal ring is fitted to a piston main body, which can satisfy sealing ability at a fitting portion between the piston main body and the seal ring and also satisfy fitting force (separation load) of the seal ring with respect to the piston main body.

### Means for Solving the Problem

According to a first aspect of the present invention to effectively solve the above-described technical problems, a piston for an automatic transmission includes a piston main body having a pressure receiving portion extending in a radial direction and a cylindrical portion bending and extending from the pressure receiving portion, and being arranged movably in an axial direction in a clutch cylinder, and a seal ring fitted to the piston main body. The seal ring includes a metal ring and a seal main body made of a rubber-like elastic material and integrated with the metal ring. The metal ring includes a fitting cylinder portion fitted to the cylindrical portion, an enlarged diameter portion formed adjacently to the fitting cylinder portion in an axial direction, and a flange portion extending in an inward radial direction from an end portion of the fitting cylinder portion or the enlarged diameter portion and being opposed to the pressure receiving portion in an axial direction. The seal main body includes a seal lip contacted with a cylindrical inner surface of the clutch cylinder tightly and slidably in an axial direction, and a compression seal portion provided on an inner peripheral surface of the enlarged diameter portion and interposed in a state of being compressed in a radial direction between the cylindrical portion of the piston main body and the enlarged diameter portion.

According to a second aspect of the present invention, the piston for an automatic transmission in the above-described first aspect is structured such that the seal main body has a second seal lip provided at the flange portion of the metal ring and tightly contacted with the pressure receiving portion of the piston main body.

### Effect of the Invention

According to the piston for an automatic transmission of the first aspect, since the metal ring of the seal ring includes the fitting cylinder portion fitted to the cylindrical portion of the piston main body, a required separation load of the seal ring with respect to the piston main body can be kept. Further, since the compression seal portion is provided at the enlarged diameter portion formed adjacently to the fitting cylinder portion in an axial direction and is tightly contacted with the cylindrical portion of the piston main body while having a proper squeeze margin, the sealing ability of the fitting portion between the piston main body and the seal ring can be improved.

Further, according to the piston for an automatic transmission of the second aspect, in addition to the effect of the first aspect, since the seal main body includes the second seal lip tightly contacted with the pressure receiving portion of the piston main body, the sealing ability between the piston main body and the seal ring can be more improved.

### BRIEF EXPLANATION OF DRAWINGS

FIG. 1 is a sectional view of a main portion of a first embodiment of a piston for an automatic transmission according to the present invention, shown by cutting it along a plane passing a shaft axis together with a part of a clutch cylinder.

FIG. 2 is a sectional view of a main portion of an example in which a part of the shape of the first embodiment is changed, shown by cutting it along a plane passing a shaft axis together with a part of a clutch cylinder.

FIG. 3 is a sectional view of a seal ring in the piston for an automatic transmission of FIG. 1, shown by cutting it along a plane passing a shaft axis.

FIG. 4 is a sectional view of a second embodiment of a piston for an automatic transmission according to the present invention, shown by cutting it along a plane passing a shaft axis.

### DETAILED DESCRIPTION OF PREFERRED EMBODIMENT

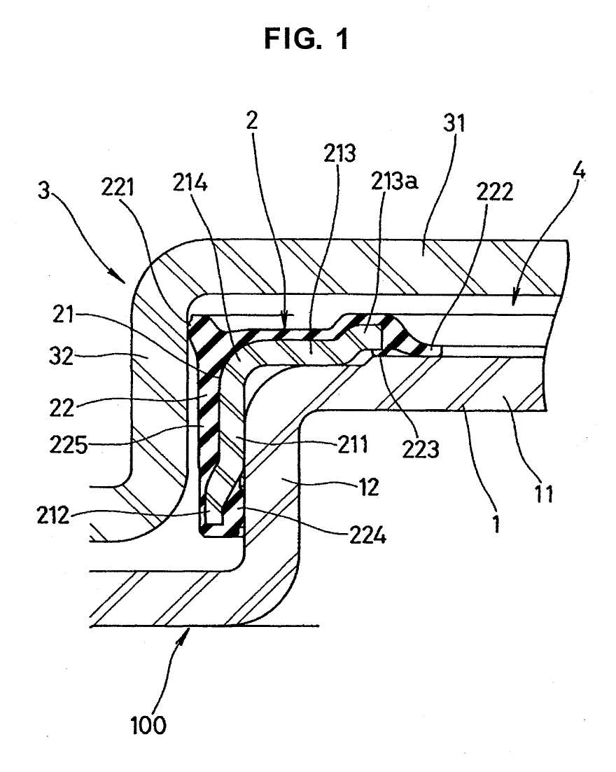

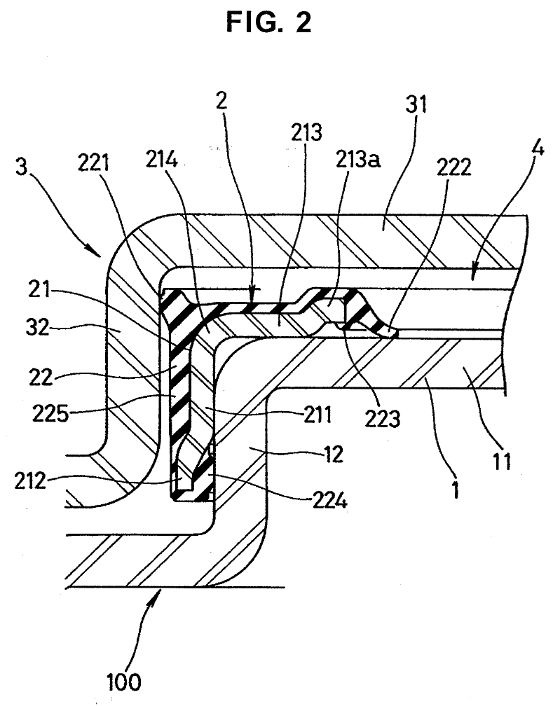

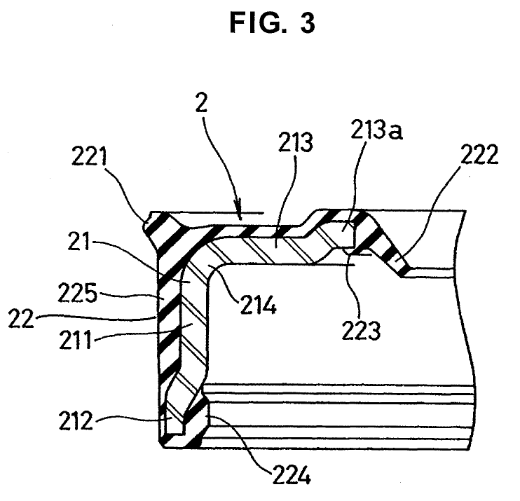

Preferred embodiments of a piston for an automatic transmission according to the present invention will be described with reference to the drawings. FIGS. 1 and 2 are sectional views of a main portion of a first embodiment of a piston for an automatic transmission according to the present invention, shown by cutting it along a plane passing a shaft axis together with a part of a clutch cylinder. FIG. 3 is a sectional view of a seal ring in the piston for an automatic transmission in FIG. 1, shown by cutting it along plane passing a shaft axis. In FIGS. 1 and 3, the left side is the outer peripheral side, the right side is the inner peripheral side, and the vertical direction is the axial direction.

A piston 100 for an automatic transmission illustrated in FIGS. 1 and 2 (hereinafter, simply referred to as the piston) is moved in an axial direction in a clutch cylinder 3 so as to connect or disconnect a clutch respectively by hydraulic pressure introduced into a hydraulic pressure chamber 4 formed between the piston 100 and an end disc portion 31 of the clutch cylinder 3, or by a return spring (not illustrated) arranged at the opposite side of the hydraulic pressure chamber 4. The piston 100 includes a piston main body 1 and a seal ring 2 fitted to the piston main body 1. The piston main body 1 is movably arranged in the axial direction in the clutch cylinder 3.

More particularly, the piston main body 1 is produced to have a ring shape by plastic processing of a metal plate such as a steel sheet. The piston main body 1 has a pressure receiving portion 11 extending in a radial direction and opposing to the end disc portion 31 of the clutch cylinder 3 in an axial direction, and a cylindrical portion 12 extending from an outer periphery of the pressure receiving portion 11 toward the opposite side of the hydraulic pressure chamber 4.

The seal ring 2 includes a metal ring 21 having an approximately L-shaped cross section obtained by cutting it along a plane passing a shaft axis, and a seal main body 22 made of a rubber-like elastic material and integrated with the metal ring 21, as illustrated in FIG. 3.

The metal ring 21 in the seal ring 2 includes a fitting cylinder portion 211 fitted to an outer peripheral surface of the cylindrical portion 12 of the piston main body 1 while having a proper squeeze margin, an enlarged diameter portion 212 formed adjacently to one end (a lower end) in the axial direction of the fitting cylinder portion 211, and a flange portion 213 which extends from another end in the axial direction (an end portion at the opposite side of the enlarged diameter portion 212) of the fitting cylinder portion 211 in the inward radial direction through a bending portion 214. The flange portion 213 is opposed to and abutted on the pressure receiving portion 11 of the piston main body 1 in the axial direction. An inner diameter end portion 213a of the flange portion 213 is bent so as to be lifted toward the hydraulic pressure chamber 4 side.

The seal main body 22 in the seal ring 2 has a seal lip 221, a second seal lip 222, a bead 223, and a compression seal portion 224. The seal lip 221 is formed at a position on an outer periphery of the bending portion 214 of the metal ring 21 and tightly and slidably contacted with an inner peripheral surface of an outer cylinder portion 32 of the clutch cylinder 3 in an axial direction. The second seal lip 222 extends to the inner peripheral side from the inner diameter end portion 213a of the flange portion 213 of the metal ring 21 and is tightly contacted with a surface at the hydraulic pressure chamber 4 side of the pressure receiving portion 11 of the piston main body 1. The bead 223 is provided on an opposite surface to the pressure receiving portion 11 of the inner diameter end portion 213a of the flange portion 213. The compression seal portion 224 is provided on an inner peripheral surface of the enlarged diameter portion 212 of the metal ring 21 and interposed in a state of being compressed in a radial direction between the cylindrical portion 12 of the piston main body 1 and the enlarged diameter portion 212. The seal lip 221, the second seal lip 222, the bead 223, and the compression seal portion 224 are formed so as to be connected each other through a film portion 225 extending so as to cover an outer peripheral surface of the fitting cylinder portion 211 of the metal ring 21 and a surface at the hydraulic pressure chamber 4 side of the flange portion 213.

In particular, in the example illustrated in FIG. 1, the pressure receiving portion 11 of the piston main body 1 has a step. Thus, the bead 223 is tightly contacted with the pressure receiving portion 11 in a compressed state in an axial direction. In the example illustrated in FIG. 2, the pressure receiving portion 11 does not have a step, and the bead 223 is not contacted with the pressure receiving portion 11.

That is, the seal ring 2 is produced by the steps of coating a vulcanizing adhesive to the annular metal ring 21 produced to have an approximately L-shaped cross section by plastic processing or the like, positioning and setting the metal ring 21 in a predetermined mold, clamping the mold, filling an unvulcanized molding rubber material into a cavity formed between an inner surface of the mold and the metal ring 21, heating and pressurizing the material, and thereby forming the seal main body 22 made of a rubber-like elastic material and bonding it via vulcanization to the metal ring 21 simultaneously.

As for the piston 100 for an automatic transmission of the first embodiment having the above-described constitution, the seal ring 2 is produced as a separate member from the piston main body 1, and then the seal ring 2 is attached to the piston main body 1. Thus, in a case of a piston having a large diameter and a complicated sectional shape, it is not necessary to produce a large and complicated mold, like a case of producing a seal integrated piston (a bonded piston seal) having a seal portion integrated with a piston main body. Further, the seal ring 2 can be produced by forming the seal main body 22 integrally with the metal ring 21 having an approximately L-shaped simple cross section as described above. Therefore, a production cost can be reduced.

Further, the piston 100 for an automatic transmission is displaced in an axial direction in the clutch cylinder 3 while resisting pressing force of a return spring (not illustrated) so as to connect and operate a multiple disc clutch (not illustrated) by hydraulic pressure applied to the hydraulic pressure chamber 4, inner and outer peripheries of which are sealed by the seal lip 221 and a sealing means (not illustrated) to seal an inner peripheral portion of the piston main body 1.

As for the seal ring 2, since the fitting cylinder portion 211 of the metal ring 21 is fitted to the outer peripheral surface of the cylindrical portion 12 of the piston main body 1 while having a proper squeeze margin, the sufficient separation load with respect to the piston main body 1 is kept. Thus, dropping of the seal ring 2 from the piston main body 1 can be prevented. Further, the second seal lip 222 is tightly contacted with a surface at the hydraulic pressure chamber 4 side of the pressure receiving portion 11 of the piston main body 1, and has a self-sealing function to increase surface pressure of the second seal lip 222 with respect to the pressure receiving portion 11 according to an increase of hydraulic pressure of the hydraulic pressure chamber 4. Further, the bead 223 provided at the outer peripheral side of the second seal lip 222 is tightly contacted with the pressure receiving portion 11 as illustrated in the example of FIG. 1 so as to have a sealing function.

As for the second seal lip 222 (or the second seal lip 222 and the bead 223), if there is a slight error in a fitting position in the axial direction of the metal ring 21 with respect to the cylindrical portion 12 of the piston main body 1, a tightly contact state of the second seal lip 222 (or the second seal lip 222 and the bead 223) with respect to the pressure receiving portion 11 of the piston main body 1 may be changed and a space may be formed between the second seal lip 222 and the pressure receiving portion 11 in an extreme case. However, in the above-described first embodiment, the compression seal portion 224 provided on an inner peripheral surface of the enlarged diameter potion 212 formed at a lower end of the fitting cylinder portion 211 of the metal ring 21 is provided between the cylindrical portion 12 of the piston main body 1 and the metal ring 21 in a compressed state in the radial direction. Therefore, even if a fitting position in the axial direction of the metal ring 21 with respect to the cylindrical portion 12 of the piston main body 1 is shifted, the sealing ability of the fitting portion between the seal ring 2 and the piston main body 1 can be kept by the compression seal portion 224, and thus hydraulic pressure applied to the hydraulic pressure chamber 4 can be properly kept.

Therefore, the sufficient separation load of the seal ring 2 with respect to the piston main body 1 can be kept, and also the sealing ability of the fitting portion between the seal ring 2 and the piston main body 1 can be kept.

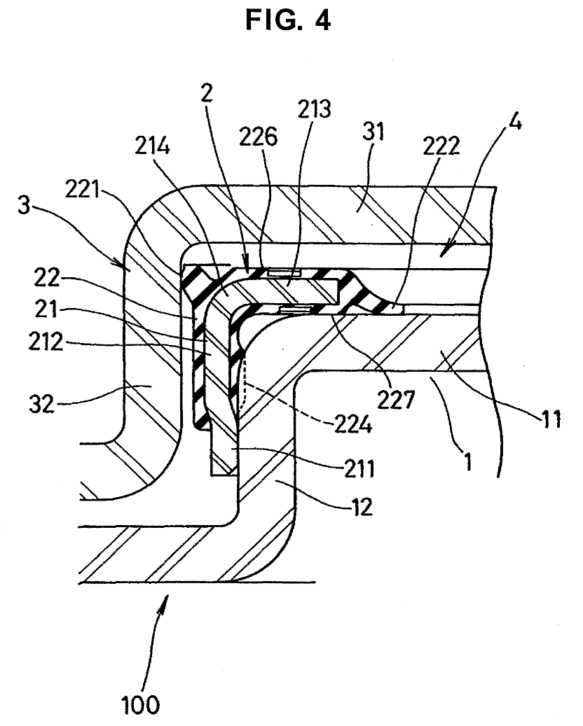

FIG. 4 is a sectional view of a second embodiment of a piston for an automatic transmission according to the present invention, shown by cutting it along a plane passing a shaft axis. In FIG. 4, the left side is the outer peripheral side, the right side is the inner peripheral side, and the vertical direction is the axial direction.

In this embodiment, the fitting cylinder portion 211 and enlarged diameter potion 212 (the compression seal portion 224 of the seal main body 22) of the metal ring 21 in the seal ring 2 are arranged in a reverse positional relation to those in FIGS. 1 to 3 with respect to the axial direction. That is, the metal ring 21 includes a fitting cylinder portion 211, an enlarged diameter portion 212, and a flange portion 213. The fitting cylinder portion 211 is fitted to an outer peripheral surface of a cylindrical portion 12 of a piston main body 1 while having a proper squeeze margin. The enlarged diameter potion 212 is formed adjacently in the axial direction at the opposite side to a lower end of the fitting cylinder portion 211. The flange portion 213 extends from an end portion at the opposite side to the fitting cylinder portion 211 in the enlarged diameter potion 212 in the inward radial direction through a bending portion 214, and is opposed to and abutted on the pressure receiving portion 11 of the piston main body 1 in the axial direction.

The seal main body 22 in the seal ring 2 includes a seal lip 221, a second seal lip 222, and a compression seal portion 224. The seal lip 221 is formed at a position on an outer periphery of the bending portion 214 of the metal ring 21 and tightly and sildably contacted with an inner peripheral surface of an outer cylinder portion 32 of the clutch cylinder 3 in an axial direction. The second seal lip 222 extends to the inner peripheral side from an inner diameter end portion of the flange portion 213 of the metal ring 21 and is tightly contacted with a surface at the hydraulic pressure chamber 4 side of the pressure receiving portion 11 of the piston main body 1. The compression seal portion 224 is provided on an inner peripheral surface of the enlarged diameter portion 212 of the metal ring 21 and interposed in a compressed state in a radial direction between the cylindrical portion 12 of the piston main body 1 and the enlarged diameter portion 212. The seal lip 221, the second seal lip 222, and the compression seal portion 224 are formed so as to be connected each other through an outer side film portion 226 extending so as to cover an outer peripheral surface of the fitting cylinder portion 211 of the metal ring 21 and a surface at the hydraulic pressure chamber 4 side of the flange portion 213, and through an inner side film portion 227 extending along an inner side surface of the flange portion 213 from the outer side film portion 226 through an inner peripheral surface of the inner diameter end portion of the flange portion 213.

Also for the seal ring 2 of the piston 100 for an automatic transmission of this second embodiment, since the fitting cylinder portion 211 of the metal ring 21 is fitted to the outer peripheral surface of the cylindrical portion 12 of the piston main body 1 while having a proper squeeze margin, the sufficient separation load with respect to the piston main body 1 is kept. Thus, dropping of the seal ring 2 from the piston main body 1 can be prevented. Further, the second seal lip 222 is tightly contacted with a surface at the hydraulic pressure chamber 4 side of the pressure receiving portion 11 of the piston main body 1, and has a self-sealing function to increase surface pressure of the second seal lip 222 with respect to the pressure receiving portion 11 according to an increase of hydraulic pressure of the hydraulic pressure chamber 4. Furthermore, the compression seal portion 224 provided on the inner peripheral surface of the enlarged diameter portion 212 of the metal ring 21 is interposed in a compressed state in the radial direction between the cylindrical portion 12 of the piston main body 1 and the enlarged diameter portion 212. Therefore, even if a fitting position in the axial direction of the metal ring 21 with respect to the cylindrical portion 12 of the piston main body 1 has an error, the sealing ability of the fitting portion between the seal ring 2 and the piston main body 1 can be kept by the compression seal portion 224, and thus hydraulic pressure applied to the hydraulic pressure chamber 4 can be properly kept.

In the second embodiment, during a step to attach the seal ring 2 to the piston main body 1, the fitting cylinder portion 211 of the metal ring 21 is pressed to fit on the outer peripheral surface of the cylindrical portion 12 in the piston main body 1, and then the compression seal portion 224 is pressed to fit on the outer peripheral surface of the cylindrical portion 12. Therefore, a tightly contact surface of the outer peripheral surface of the cylindrical portion 12 to the compression seal portion 224 may be damaged when the fitting cylinder portion 211 of the metal ring 21 is pressed to fit before the compression seal portion 224 is pressed, thereby the reliability of sealing by the compression seal portion 224 being decreased. Therefore, when this point is considered, the previously described first embodiment is more preferable than the second embodiment.

Further, according to the second embodiment, the compression seal portion 224 is formed by entering a molding rubber material along the inner side surface of the flange portion 213 through the inner peripheral surface of the inner diameter end portion of the flange portion 213 of the metal ring 21, due to the positional relation with the fitting cylinder portion 211 which is fitted to the outer peripheral surface of the cylindrical portion 12 of the piston main body 1 in metal contact. Thus, the inner side film portion 227 to cover the inner side surface of the flange portion is formed between the second seal lip 222 and the compression seal portion 224. Further, when the seal ring 2 is attached to the piston main body 1, the inner side film portion 227 is provided between the flange portion 213 and the pressure receiving portion 11 of the piston main body 1. Thus, the accuracy to position the seal ring 2 with respect to the axial direction of the piston main body 1 is decreased by the axial compressibility of the inner side film portion 227. Therefore, when this point is considered, the previously described first embodiment is more preferable than the second embodiment.

What is claimed is:

1. A piston for an automatic transmission comprising:
a piston main body having a pressure receiving portion extending in a radial direction and a cylindrical portion bending and extending from the pressure receiving portion, and being arranged movably in an axial direction in a clutch cylinder; and
a seal ring fitted to the piston main body, wherein the seal ring comprises a metal ring and a seal main body made of a rubber-like elastic material and integrated with the metal ring,
wherein the metal ring comprises a fitting cylinder portion fitted to the cylindrical portion, an enlarged diameter portion formed adjacently to the fitting cylinder portion in an axial direction, and a flange portion extending in an inward radial direction from an end portion of the fitting cylinder portion or the enlarged diameter portion and being opposed to the pressure receiving portion in an axial direction, and
wherein the seal main body comprises a seal lip contacted with a cylindrical inner surface of the clutch cylinder tightly and slidably in an axial direction, and a compression seal portion provided on an inner peripheral surface of the enlarged diameter portion and interposed in a state of being compressed in a radial direction between the cylindrical portion of the piston main body and the enlarged diameter portion.

2. The piston for an automatic transmission as claimed in claim 1,
wherein the seal main body includes a second seal lip provided at the flange portion of the metal ring and tightly contacted with the pressure receiving portion of the piston main body.
